(19) United States
(12) Patent Application Publication
(10) Pub. No.: US 2004/0078226 A1
(43) Pub. Date: Apr. 22, 2004

(54) Medical data processing system

(76) Inventors: Detlef Becker, Moehrendorf (DE); Karlheinz Dorn, Kalchreuth (DE); Michael Peter, Erlangen (DE); Michael Schnitzke, Erlangen (DE)

Correspondence Address: HARNESS, DICKEY & PIERCE, P.L.C., P.O.BOX 8910, RESTON, VA, 20195, US

(21) Appl. No.: 10/419,846

(22) Filed: Apr. 22, 2003

(30) Foreign Application Priority Data
Apr. 22, 2002 (DE) 10217886.0

(51) Int. Cl. G06F 17/60

(52) U.S. Cl. 705/2

(57) ABSTRACT

A medical data processing system is for local and Internet based access to medical data stored in a data store in a medical facility. The medical data processing system has a server program for local access to the data in the data storage device and a web server program, potentially extended by a web application server program, for Internet based access to the data in the data storage device. Upon a request for data from the data storage device over the Internet, the web server program and the web application server program buffer-store no process state relating to the request beyond the request.

The present application hereby claims priority under 35 U.S.C. §119 on German patent application number DE 10217886.0 filed Apr. 22, 2002, the entire contents of which are hereby incorporated herein by reference.

### FIELD OF THE INVENTION

The invention generally relates to a medical data processing system for local access to medical data stored in a data store in a medical facility.

### BACKGROUND OF THE INVENTION

Medical facilities, which are understood to include medical systems, installations or equipment, for example imaging equipment such as computer tomographs or MR equipment, generally have data stores for image data or other medical data which have been produced using the systems, installations or equipment themselves or are merely stored in the systems, installations or equipment. Such systems, installations or equipment are frequently “single user systems” which have a server program for local access to the data in the data store. As such, the medical data can be displayed on a display apparatus in the single user system, for example. To be able to display, by way of example, an image from a study on a patient, a user of the medical facility in this context first needs to look for the corresponding patient in a generally very long list of patients, find the relevant study on the patient from a potentially very large number of studies, and find and select the study's relevant image from a potentially large number of images.

A drawback of this architecture is that the data in the data store can be accessed only locally, that is to say only from the respective single user system.

### SUMMARY OF THE INVENTION

An embodiment of the invention is therefore based on an object of designing a medical data processing system such that the medical data stored in the data store in the medical facility can be accessed further in an efficient manner.

An embodiment of the invention may achieve this object, for example, through a medical data processing system. In line with an embodiment of the invention, besides local access to the medical data in the data store, additional Internet based access to the medical data in the data store is also possible. To this end, the medical data processing system has a web server program for communication and for data transfer between the data store in the medical facility and a computer, provided with a web browser, for example Netscape from the company Netscape Communications Corporation, belonging to a person interested in the medical data, a “client”. To allow a plurality of different clients to use computers provided with web browsers to access the medical data in the data store more or less in parallel from various locations efficiently, i.e. access with improved use of resources and short response times, the web server program for handling Internet based requests from the clients for medical data from the data store buffer-stores, for each client or for each request from a client, no process state relating to the request beyond the respective request. In this case, a process state is understood to include a status for a request from a client which the web server program can take as a basis for proceeding in the event of further requests from the client for data.

Following a request from a client for data, an inherently known web server program would buffer-store at least one client-specific process state relating to the request, even going beyond the request which is being dealt with, in a memory in the course of dealing with the request in order to be able to take a known state as a basis for continuing in the event of a further request from a client, i.e. in order to be able to process the further requests. With n clients, n sets of client-specific process states would thus be buffer-stored. As such, they would use resources even at times when a client is not requesting any further data following a first request. This limits the web server program's scalability, which is understood to include the number of clients which the web server program can supply with data within a time interval.

In line with an embodiment of the invention, the web server program therefore operates without states, that is to say buffer-stores no process state relating to a request from a client beyond the request. Thus, no resources beyond the request are used for each client or for each request from a client, particularly no storage space for buffer-storing process states, and hence efficient Internet access to the data stored in the data store is made possible. With this architecture, a client thus requires computation time or uses resources only when, and only for as long as, he is currently requesting medical data. This significantly increases the scalability as compared with an inherently known web server program which has to deal with states.

In the case of an embodiment of the present invention, a client's web browser therefore needs to buffer-store not just medical data for display on a visual display unit, but also at least one process state, relating to a first request for medical data from the data store, about the request sequence or workflow. This is done in order to be able to notify the web server program of how to proceed, following a first request for data, in the event of a second or further request for data.

The medical data processing system is in a form such that the server program for local access and the web server program for Internet based access operate independently of one another and without any reaction to one another. Even if data in the data store in the medical facility are accessed locally, various clients can access data in the data store more or less in parallel from various locations without affecting one another. Besides this, the server program for local access and the web server program for Internet based access can also access the same data store in a medical facility directly. In this case, direct access is understood to mean that, for local or Internet based access, the data in the data store in the medical facility are not copied to one or more additional data stores which would then be accessed; this would entail large data transfers and would take up twice the storage space.

The medical data processing system can be used for any medical systems, even those already existing.

In line with one embodiment of the invention, the web server program is extended by a web application server program, with both the web server program and the web application server program operating without states. Upon a request from a client for data from the data store in the medical facility over the Internet, the web server program and the web application server program accordingly buffer-store, for each request, no process state relating to the request beyond the request.

In line with one variant of the invention, the web server program or the web application server program is extended by a plug-in. In this case, a plug-in is understood to be a software module which acts as an interface between the web server program and the data store or between the web application server program and the data store in the medical facility. The plug-in thus interacts between the web server program and the data store or between the web application server program and the data store in the medical facility.

In line with one embodiment of the invention, the plug-in has two software components, with the first component retrieving the requested data from the data store in the medical facility and the second component preparing the data retrieved from the data store for the purpose of forwarding to a client who is requesting the data. In this case, the second software component ensures that the data retrieved from the data store are modified in a suitable manner or are provided with additional information so that they can be delivered over the Internet to the client who is requesting the data.

In line with one variant of an embodiment of the invention, the first software component includes a data format converter program, a “data connector”. On the basis of a request for medical data, the data format converter program reads the appropriate medical data from the data store, converts the data, if required, into a data format supported by the web server program or into a data format supported by the web application server program, and delivers the possibly converted medical data, following processing by the second component of the plug-in, to the web server program or to the web application server program. The medical data processing system can thus be used to access virtually any medical data store irrespective of the data format of the data stored in the data store if the data store has such a data format converter program available. In line with one variant of an embodiment of the invention, the data format converter program delivers the data to the web application server program, preferably as a string or an XML document.

To prevent a request for medical data, for example, for patients' identification data, from involving all the data available therefor being read from the data store even though sometimes only some of the data are required by the client, which would have an adverse effect on the scalability, one variant of the invention provides that, upon a request for data from the data store over the Internet, the data are transmitted in data packets of a particular size, “chunks”. A request for patients' identification data accordingly involves only a data packet which contains identification data for a particular number of patients initially being transferred to the client's computer. If the client requires further identification data for patients, he needs to request them specially. This increases the scalability, since the volume of the medical data transferred for each request is not dependent on the volume of the medical data relating to the request in the data store. In addition, this form of transmitting medical data reduces the memory requirement for processing a large number of parallel requests. In line with one variant of an embodiment of the invention, the size of the data packets is adjustable.

In line with another variant of an embodiment of the invention, in the event of a request for data from the data store which have a volume large enough that they ought not to be transmitted in one data packet, a first data packet is transmitted and, if the desired data were still not contained in the first data packet, further data packets are transmitted upon request, with no data among the requested data from the data store being transmitted more than once. The data matching the request are thus split into data packets whose content does not overlap, and are transmitted to the requesting client as appropriate. This allows a client, for example searching for a particular image for a patient in a study on the patient, to obtain the desired image iteratively without data being transmitted to the client in duplicate in data packets, which would mean that resources are used unnecessarily.

### BRIEF DESCRIPTION OF THE DRAWINGS

Exemplary embodiments of the invention are illustrated in the appended schematic drawings, in which:

FIG. 1 shows an inventive medical data processing system for local and Internet based access to data stored in a data store in a medical facility,

FIG. 2 shows the sequence for a request for data over the Internet using the medical data processing system from FIG. 1,

FIG. 3 shows the sequence for a request for data over the Internet using the medical data processing system from FIG. 1, which transmits data packets to a client, and

FIG. 4 shows an exemplary embodiment of the invention, in which the data transfer between data stores and the web application server program takes place using data format converter programs.

### DETAILED DESCRIPTION OF THE PREFERRED EMBODIMENTS

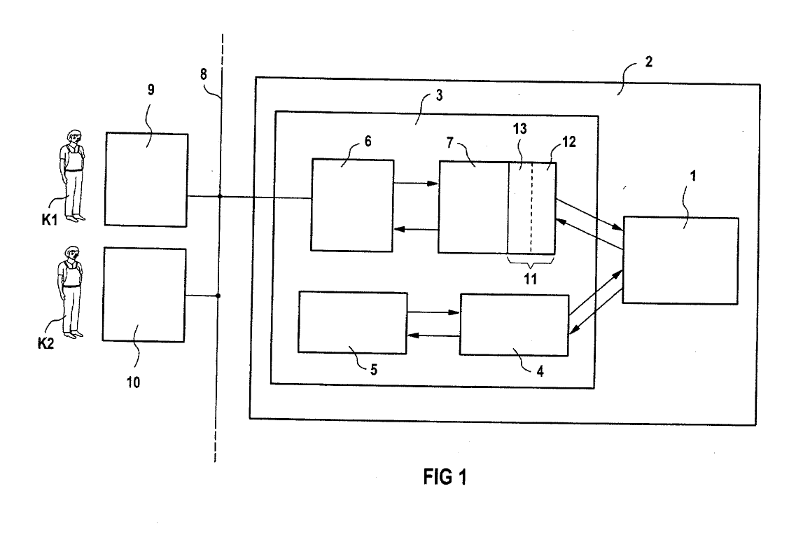

FIG. 1 shows the architecture of an inventive medical data processing system for local and Internet based access to medical data stored in a data storage device 1 in a medical facility 2. The medical facility 2 in the case of the present exemplary embodiment is a piece of MR equipment 2 whose data storage device 1 stores identification data, studies and image data for a plurality of patients. In addition, the MR equipment 2, shown merely in block diagram form, has a computer or processor 3 for executing various programs for accessing the data in the data storage device 1.

The MR equipment 2 is a “single user medical imaging system”, that is to say a piece of equipment whose data stored in the data storage device 1 can be accessed only locally. To this end, the MR equipment 2 has a server program 4, which is also referred to as a “single user server”. The server program 4 can be used to retrieve, by way of example, medical image data from the data storage device 1 and to make them available to a program 5, a “single user client”, for the purpose of further handling of the image data, for example for displaying the image data on a display device (not shown) on the MR equipment 2.

To be able to make the medical data stored in the data storage device 1 in the MR equipment 2 available to other interested parties, “clients”, as well, the MR equipment 2 in the case of the present exemplary embodiment, has a web server program 6 extended by a web application server program 7. The web server program 6 and the web application server program 7 allow clients with access to a computer provided with a web browser, e.g. Netscape from the company Netscape Communications Corporation, to use the Internet 8 to access the medical data in the data storage device 1, which can also be accessed by the server program 4. In the case of the present exemplary embodiment, the web application server program 7 is extended by a plug-in 111 which is used as an interface between the web application server program 7 and the data storage device 1. The plug-in 11 is a software module which has two components 12, 13, the first component 12 handling the data transfer between the web application server program 7 and the data storage device 1 in the MR equipment 2, and the second component 13 being responsible for preparing the data retrieved from the data store 1 for the purpose of forwarding to a client K1, K2 who is requesting the data. The first component 12 includes a data format converter program which, on the basis of a request for data, reads the data from the data storage device 1, if required converts them into a data format supported by the web application server program 7, and delivers the possibly converted data, following processing by the second component 13 of the plug-in 11, which provides the data with additional information, to the web application server program 7.

FIG. 1 shows, by way of example, two computers 9, 10 which are connected to the Internet 8 and belong to clients K1, K2. The clients K1 and K2 can access the data in the data storage device 1 from various locations in parallel with one another and in parallel with local access to the data in the data storage device 1. In this case, local access and Internet 8 based access are independent of one another and have no reaction to one another, i.e. they do not affect one another. Both local access and Internet 8 based access are effected directly to the data storage device 1. Thus, the data in the data storage device 1 are not copied to another data store, for example one provided for Internet based access.

So that clients, such as the clients K1 and K2, can access the medical data in the data storage device 1 efficiently, the web server program 6 and the web application server program 7 interact such that no process states relating to a request from a client for medical data are buffer-stored in a store in the MR equipment 2 beyond the processing of the request. For each request from a client, the client thus uses no resources beyond the request.

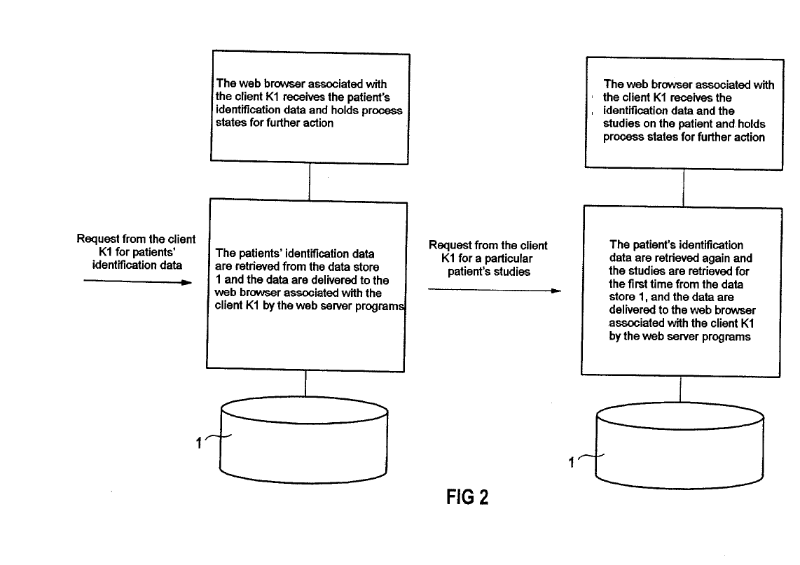

FIG. 2 shows, by way of example, the sequence for a request from the client K1 for medical data from the data store 1 over the Internet 8. In the case of the present exemplary embodiment, the client K1 uses his computer 9, provided with a web browser, to request patients' identification data from the web server program 6 extended by the web application server program 7. The web application server program 7 uses the plug-in 11 to retrieve the patients' identification data from the data storage device 1, and the web server program 6 transmits the patients' identification data to the web browser associated with the client K1. It is fundamental in this context that the web server program 6 and the web application server program 7 operate without states, that is to say buffer-store no process states relating to the request from the client K1 for the patients' identification data beyond the processing of the current request.

In this context, a process state is understood to refer to a status for the request from a client which the web server program can take as a basis for proceeding in the event of further requests from the client. Instead, storage of one or more such process states is the responsibility of the web browser associated with the client K1. Accordingly, the web browser associated with the client K1 receives the patients' identification data and holds at least one process state ready for further action. If the client K1 requests studies on a particular patient whose identification data has been delivered beforehand as a result of the client K1 activating, by way of example, an appropriate hyperlink associated with the identification data by clicking on it with a computer mouse, the web application server program 7 uses the plug-in 11 to retrieve the patient's identification data again and the patient's studies for the first time from the data storage device 1, and the web server program 6 delivers these to the web browser associated with the client K1.

The web server program 6 and the web application server program 7 in turn hold no process state beyond the processing of the current request from the client K1. Instead, the web browser associated with the client K1 receives the identification data and the studies on the patient and holds at least one process state ready for further action. Since the web server program 6 and the web application server program 7 thus do not store any process states relating to the request from the client K1 for data from the data storage device 1, processing the requests from the client K1 requires computation time, or the client K1 uses memory resources, only if and only for as long as he is currently requesting data. This significantly increases the scalability as compared with an inherently known web server program which has to deal with states, which, upon requests from clients for data, stores, for each client, process states for the further action, which uses memory resources and indicates that they are no longer available for processing further requests for data.

The text below shows, by way of example, a portion of an HTML page on a web browser associated with a client, which contains a list of patients' names and three links. Each of the portion's links contains process states in the form of parameters for patient identification and in the form of a command for the further action for delivering studies. These process states can be used by the web server program to establish what the process state is and what needs to be done next.

List of Patients:

Click on Patient Name to View Patient's Studies

```
<tr>
  <td>
  <a
  href=“MyControl.aspx?patientId=1&command=getStudies>Pati
  ent Name 1</a>
  </td>
</tr>
<tr>
  <td>
  <a
  href=“MyControl.aspx?patientId=2&command=getStudies>Pati
  ent Name 2</a>
  </td>
</tr>
<tr>
  <td>
  <a
  href=“MyControl.aspx?patientID=3&command=getStudies>Pati
  ent Name 3</a>
  </td>
</tr>
...
```

The following code, indicated by way of example, relates to the web server programs' execution of a request from a client for studies:

```
public class MyControl : System.Web.UI.Page {
  protected void Page_Load(object sender, System.EventArgs
  e) {
    //...
    if(Request.QueryString[“command”].Equals(“getStu-
    dies”) ) {
      String patientId = Request.
      QueryString[“patientId”];
      //retrieve Studies for Patient from Database
      Studies[] studies = MyDB.getStudiesForPatient(
      patientId );
      //render client view
      for(int j=0;j < studies.Length;j++) {
        //...
        String studyId = studies[j].Id;
        String studyName = studies[j].Name;
        Response.Write( “<a
        href=“MyControl.aspx?studyId=”+studyId
        +
          “&command=getSeries>”+studyName+
          “</a>”;
        //...
      }
    }else if(Request.QueryString[“command”].Equals(
    “getSeries”) ) {
      //..
    }
  }
  //...
}
```

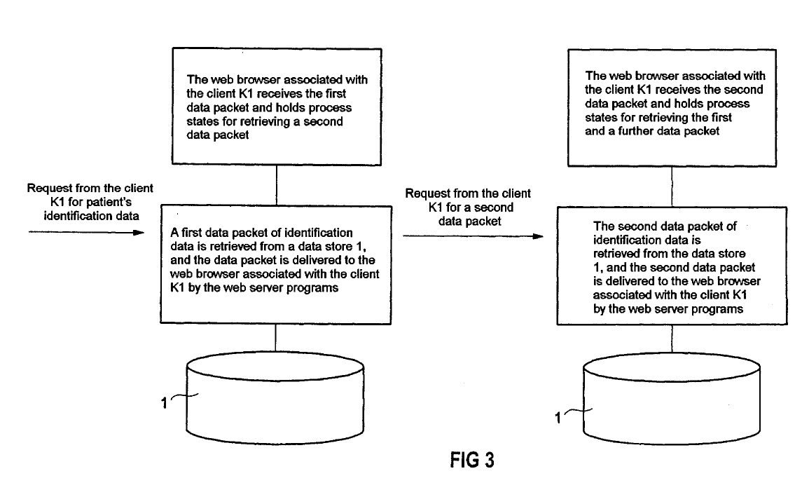

The scalability of the medical data processing system can be improved again if, upon a request for data from the data storage device 1 over the Internet 8, the data are transmitted in data packets of a particular size “chunks”. This form of data transfer is illustrated in FIG. 3, in a similar manner to the sequence shown in FIG. 2 for a request from a client K1 for patients' identification data over the Internet 8. If the client K1 uses his web browser to request patients' identification data, the web application server program 7 uses the plug-in 11 to retrieve a first data packet of a particular size containing patients' identification data from the data storage device 1, and the web server program 6 transmits the first data packet containing patients' identification data to the web browser associated with the client K1. In general, the size of the data packet can be stipulated in this context.

The web browser associated with the client K1 receives the first data packet and holds process states ready for the retrieval of a second data packet. Upon a further request from a client K1, the web application server program 7 uses the plug-in 11 to retrieve a second data packet of a particular size containing patients' identification data from a data storage device 1, and the web server program 6 transmits the second data packet containing patients' identification data to the web browser associated with the client K1. The web browser associated with the client K1 receives the second data packet and holds process states ready for retrieval of the first and a further data packet. The client K1 can now, in the manner outlined, request further data packets containing patients' identification data or can request one or more patients' studies, which are likewise transmitted in the form of data packets. In this case, contents of the data packets, which contain only data in a particular category, for example only patient identification data or only image data, advantageously do not overlap, which means that no memory resources are used unnecessarily when transmitting the data packets.

In this way, the client K1 can iteratively obtain the desired patient or a desired image from a study on the desired patient. In this context, the web server program 6 and the web application server program 7 again operate without states, that is to say buffer-store no process states relating to the requests for the data packets beyond the respective request. The advantage of this form of data transfer is that the volume of the data to be transmitted can be reduced, since the volume of the data transmitted for each request is independent of the volume of the data relating to the request in the data storage device 1, i.e. generally only some of the data associated with a request are ever transmitted to a client's web browser. Hence, this also increases the scalability, particularly if the content of the data packets does not overlap. In addition, the response times to requests from clients are also improved in this manner.

The text below shows an example of a link, as held by a client's web browser, for requesting a subsequent data packet.

<a href=“MyControl.aspx?lastPatientName=Patient4&command=getPatientsNext&chunkSize=4>Show next Patientsd</a>

The web server program uses the “command” parameter to identify that the next data packet needs to be delivered. In this case, the “lastPatientName” parameter identifies the last name of a patient in a data packet already delivered and the “chunkSize” parameter indicates the size of the next data packet to be delivered.

The text below shows, by way of example, a code fragment for executing the request for a subsequent data packet.

```
//...
if( Request.QueryString[“command”].Equals( “getPatientsNext”
) ) {
    String lastPatientName = Request.
    QueryString[“lastPatientName”];
    int chunkSize = Convert.toInt32( Request.
    QueryString[“chunkSize”] );
    //retrieve Patient chunk
    Patients[] patients=MyDB.getNextPatientChunk(lastPa-
    tient Name, chunkSize );
    for( int j=0;j < patients.Length;j++) {
      String patientName = patients[j].Name;
      String patientId = patients[j].Id;
      //...
      Response.Write(“<a href=”MyControl.aspx?patientId=“
      + patientId +
        “&command=getStudies>”+patientName+“</a>”;
      //...
}
//...
Response.Write(<a href=“MyControlxaspx?lastPatientName=”
+ patients[patients.Length−1].Name +
“&command=getPatients&chunksSize=4>Show next Pati-
ents</a>”;
Response.Write(<a
href=“MyControl.aspx?firstPatientName=” + pati-
ents[0].Name +
“&command=getPatientsBack&chunkSize=4>Show previous Pa-
tients</a>”;
}
//...
```

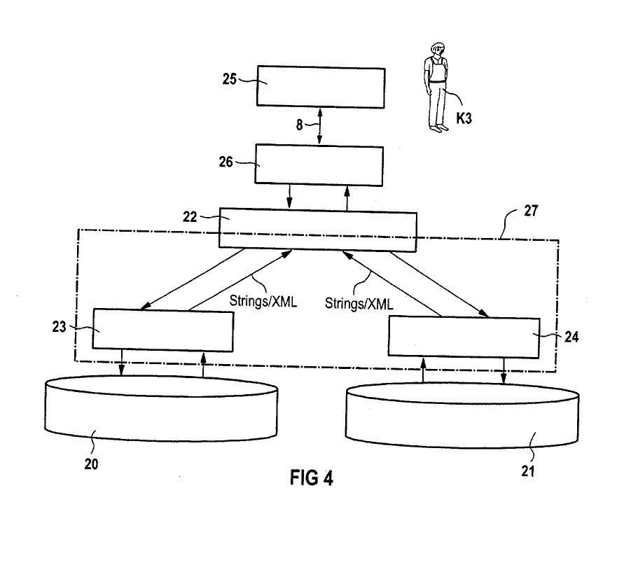

FIG. 4 shows an exemplary embodiment of the invention in which the data transfer between two data stores 20, 21 and a web application server program 22 extended by a plug-in 27 will be explained again in more detail. As already mentioned above, the plug-in 27 has a data format converter program, in the case of the present exemplary embodiment even two data format converter programs 23, 24, “data connectors”. In this case, the data stores 20, 21 can be associated with one or else with various medical facilities. If a client K3 uses his computer 25, provided with a web browser, to request data from a web server program 26, then, depending on which data have been requested, the web application server program 22 retrieves the requested data either from the data store 20 via the data format converter program 23 in the plug-in 27 or from the data store 21 via the data format converter program 24 in the plug-in 27. The web server program 26 then transmits them, following appropriate processing by the second component (not shown in more detail) of the plug-in 27, to the web browser associated with the client K3 over the Internet 8. In this case, the data format converter program 20 or the data format converter program 21 reads the requested data from a data store 20 or 21 and delivers the data to the web application server program 22, preferably as a string or an XML document. In this way, the medical data processing system can be used to access virtually any medical data store if the data store has such a data format converter program available which converts data held in a data store into a string or an XML document.

The following exemplary lines of code again show a request for three studies on a patient having the patient identification 3711 for the architecture shown in FIG. 4:

“GETSTUDIES_CHUNK”, “ ”//operation identifier (what to do at the server)

“PARAM1”, “3711” // a patient id

“PARAM2”, “0” // the number of the chunk

“PARAM3”, “3” // the size of the chunk

The text below shows an example of an XML response to the request:

```
<Studies>
  <Study>
    <id>2111</id>
    <No>0</No>
    <description>Study A</description>
    <date>20001104</date>
  </Study>
  <Study>
    <id>2112</id>
    <No>1</No>
    <description>Study B</description>
    <date>20001125</date>
  </Study>
  <Study>
    <id>2113</id>
    <No>2</No>
    <description>Study C</description>
    <date>20001205</date>
  </Study>
</Studies>
```

The way in which the inventive medical data processing system works has been explained above using the example of a piece of MR equipment. However, the medical data processing system can also be used for other medical installations, systems or equipment.

As an aside, the medical data processing system does not necessarily have to have a web application server program. Instead, an architecture with just a web server program extended by a plug-in is also possible.

It goes without saying that any hybrid forms of the invention's exemplary embodiments illustrated by way of example with reference to the figures are possible.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A medical data processing system for local and Internet based access to medical data stored in a data storage device in a medical facility, the system comprising:
a server program for local access to the data in the data storage device; and
a web server program for Internet based access to the data in the data storage device, wherein the server program for local access and the web server program for Internet based access operate independently of one another and without any reaction to one another, wherein the server program for local access and the web server program for Internet based access are adapted to access the same data storage device in the medical facility, and wherein, upon a request for data from the data storage device over the Internet, the web server program is adapted to buffer-store, for each request, no process state relating to the request beyond the request.

2. The medical data processing system as claimed in claim 1, wherein the web server program is extended by a web application server program, where, upon a request for data from the data storage device over the Internet, the web server program and the web application server program are adapted to facilitate buffer-storage, for each request, of no process state relating to the request beyond the request.

3. The medical data processing system as claimed in claim 2, wherein at least one of the web server program and the web application server program is extended by a plug-in, adapted to act as an interface between at least one of the web server program and the data storage device, and between the web application server program and the data storage device in the medical facility.

4. The medical data processing system as claimed in claim 3, wherein the plug-in includes two components, the first component being adapted to retrieve the requested data from the data storage device in the medical facility and the second component adapted to prepare the data retrieved from the data storage device for the purpose of forwarding to a client requesting the data.

5. The medical data processing system as claimed in claim 4, wherein the first component includes a data format converter program which, on the basis of a request for data, is adapted to read the data from the data storage device, convert the data, if required, into a data format supported by at least one of the web server program and the web application server program, and deliver the possibly converted data, following processing by the second component of the plug-in, to at least one of the web server program and the web application server program.

6. The medical data processing system as claimed in claim 5, wherein the data are delivered as at least one of a string and an XML document.

7. The medical data processing system as claimed in claim 1, wherein, upon a request for data from the data storage device over the Internet, the data are transmitted in data packets of a particular size.

8. The medical data processing system as claimed in claim 7, wherein the size of the data packets is adjustable.

9. The medical data processing system as claimed in claim 7, wherein, in the event of a request for data from a data storage device which have a volume large enough that they ought not to be transmitted in one data packet, a first data packet is adapted to be transmitted and, if the desired data were still not contained in the first data packet, further data packets are adapted to be transmitted upon request, with the content of the data packets not overlapping.

10. The medical data processing system as claimed in claim 1, wherein the server program and web server program are adapted to be stored in a data storage device of the system and are adapted to be run on a processor of the system.

11. The medical data processing system as claimed in claim 1, wherein the web server program is extended by a plug-in, adapted to act as an interface between the web server program and the data storage device in the medical facility.

12. The medical data processing system as claimed in claim 11, wherein the plug-in includes two components, the first component being adapted to retrieve the requested data from the data storage device in the medical facility and the second component adapted to prepare the data retrieved from the data storage device for the purpose of forwarding to a client requesting the data.

13. The medical data processing system as claimed in claim 12, wherein the first component includes a data format converter program which, on the basis of a request for data, is adapted to read the data from the data storage device, convert the data, if required, into a data format supported by the web server program, and deliver the possibly converted data, following processing by the second component of the plug-in, to the web server program.

14. The medical data processing system as claimed in claim 8, wherein, in the event of a request for data from a data storage device which have a volume large enough that they ought not to be transmitted in one data packet, a first data packet is adapted to be transmitted and, if the desired data were still not contained in the first data packet, further data packets are adapted to be transmitted upon request, with the content of the data packets not overlapping.

15. A medical data processing system for local and Internet based access to medical data stored in a medical facility, the system comprising:
a processor; and
a storage device, the storage device storing,
a server program for, when run in conjunction with the processor, providing local access to the data stored in the medical facility, and
a web server program for, when run in conjunction with the processor, providing Internet based access to the data in the medical facility, wherein the server program for local access and the web server program for Internet based access operate independently of one another and without any reaction to one another, wherein the server program for local access and the web server program for Internet based access are adapted to provide access to the same data storage device in the medical facility, and wherein, upon a request for data from the data storage device over the Internet, the web server program is adapted to provide buffer storage, for each request, of no process state relating to the request beyond the request.

16. The medical data processing system as claimed in claim 15, wherein the web server program is extended by a plug-in, adapted to act as an interface between the web server program and the data storage device in the medical facility.

17. The medical data processing system as claimed in claim 16, wherein the plug-in includes two components, the first component being adapted to retrieve the requested data from the data storage device in the medical facility and the second component adapted to prepare the data retrieved from the data storage device for the purpose of forwarding to a client requesting the data.

18. The medical data processing system as claimed in claim 17, wherein the first component includes a data format converter program which, on the basis of a request for data, is adapted to read the data from the data storage device, convert the data, if required, into a data format supported by the web server program, and deliver the possibly converted data, following processing by the second component of the plug-in, to the web server program.

19. The medical data processing system as claimed in claim 15, wherein the web server program is extended by a web application server program, where, upon a request for data from the data storage device over the Internet, the web server program and the web application server program are adapted to facilitate buffer-storage, for each request, of no process state relating to the request beyond the request.

20. The medical data processing system as claimed in claim 18, wherein the data are delivered as at least one of a string and an XML document.

21. The medical data processing system as claimed in claim 15, wherein, upon a request for data from the data storage device over the Internet, the data are transmitted in data packets of a particular size.

22. The medical data processing system as claimed in claim 21, wherein the size of the data packets is adjustable.

23. The medical data processing system as claimed in claim 21, wherein, in the event of a request for data from a data storage device which have a volume large enough that they ought not to be transmitted in one data packet, a first data packet is adapted to be transmitted and, if the desired data were still not contained in the first data packet, further data packets are adapted to be transmitted upon request, with the content of the data packets not overlapping.

24. The medical data processing system as claimed in claim 22, wherein, in the event of a request for data from a data storage device which have a volume large enough that they ought not to be transmitted in one data packet, a first data packet is adapted to be transmitted and, if the desired data were still not contained in the first data packet, further data packets are adapted to be transmitted upon request, with the content of the data packets not overlapping.

25. A medical data processing system for local and Internet based access to medical data stored in a medical facility, the system comprising:
first means for storing a server program and a web server program; and
second means for, in conjunction with the server program, providing local access to the data stored in the medical facility and for, in conjunction with the web server program, providing Internet based access to the data in the medical facility, wherein the server program for local access and the web server program for Internet based access operate independently of one another and without any reaction to one another, wherein the server program for local access and the web server program for Internet based access are adapted to, in conjunction with the second means, provide access to the same data storage device in the medical facility, and wherein, upon a request for data from the data storage device over the Internet, the second means, in conjunction with the web server program, is adapted to provide buffer storage, for each request, of no process state relating to the request beyond the request.

26. The medical data processing system as claimed in claim 25, wherein the web server program is extended by a plug-in, adapted to act as an interface between the web server program and the data storage device in the medical facility.

27. The medical data processing system as claimed in claim 26, wherein the plug-in includes two components, the first component being adapted to retrieve the requested data from the data storage device in the medical facility and the second component adapted to prepare the data retrieved from the data storage device for the purpose of forwarding to a client requesting the data.

28. The medical data processing system as claimed in claim 27, wherein the first component includes a data format converter program which, on the basis of a request for data, is adapted to, in conjunction with the second means, read the data from the data storage device, convert the data, if required, into a data format supported by the web server program, and deliver the possibly converted data, following processing by the second component of the plug-in, to the web server program.

29. The medical data processing system as claimed in claim 25, wherein the web server program is extended by a web application server program, where, upon a request for data from the data storage device over the Internet, the web server program and the web application server program, in conjunction with the second means, are adapted to facilitate buffer-storage, for each request, of no process state relating to the request beyond the request.

30. The medical data processing system as claimed in claim 28, wherein the data are delivered as at least one of a string and an XML document.

31. The medical data processing system as claimed in claim 25, wherein, upon a request for data from the data storage device over the Internet, the data are transmitted in data packets of a particular size.

32. The medical data processing system as claimed in claim 31, wherein the size of the data packets is adjustable.

33. The medical data processing system as claimed in claim 31, wherein, in the event of a request for data from a data storage device which have a volume large enough that they ought not to be transmitted in one data packet, a first data packet is adapted to be transmitted and, if the desired data were still not contained in the first data packet, further data packets are adapted to be transmitted upon request, with the content of the data packets not overlapping.

34. The medical data processing system as claimed in claim 32, wherein, in the event of a request for data from a data storage device which have a volume large enough that they ought not to be transmitted in one data packet, a first data packet is adapted to be transmitted and, if the desired data were still not contained in the first data packet, further data packets are adapted to be transmitted upon request, with the content of the data packets not overlapping.
